(19) United States
(12) Patent Application Publication
(10) Pub. No.: US 2025/0319429 A1
(43) Pub. Date: Oct. 16, 2025

(54) FLUID SYSTEM HAVING FILTER CONNECTING SYSTEM BETWEEN HOUSING COMPONENTS

(71) Applicant: Caterpillar Inc., Peoria, IL (US)

(72) Inventor: Timothy S. Finn, Morton, IL (US)

(73) Assignee: Caterpillar Inc., Peoria, IL (US)

(21) Appl. No.: 18/634,213

(22) Filed: Apr. 12, 2024

(51) Int. Cl. B01D 29/96; B01D 29/11; B01D 35/00; B01D 35/30; B01D 36/00; F01M 11/03; F02M 37/32

(52) U.S. Cl. CPC B01D 29/96; B01D 29/114; B01D 35/005; B01D 35/306; B01D 36/006; F01M 11/03; F02M 37/32; B01D 2201/4007; B01D 2201/4092; F01M 2011/031

(57) ABSTRACT

A filter cartridge includes a filter housing component defining a filter axis extending between a first axial end and a second axial end, and including a peripheral surface having a plurality of thread sets and a plurality of slots. The first axial end includes an axial end surface spaced axially outward of the plurality of threads sets and the plurality of slots, and a ramp element for aligning thread sets and slots of a second filter component with the plurality of thread sets and the plurality of slots of the filter housing component. The ramp element extends circumferentially around the filter axis, and slopes in an axial direction from a heightened ramp end to a shortened ramp end.

### TECHNICAL FIELD

The present disclosure relates generally to a serviceable fluid system, and more particularly to a connecting system having a threaded connecting interface forming a drain passage therethrough.

### BACKGROUND

Various machinery and vehicles are known throughout the world which utilize filters for various purposes. Most, if not all, machinery and vehicles equipped with a diesel engine, for example, filter the diesel fuel to remove impurities that can interfere with operation of the engine, or the combustion process itself. As particles are collected in the filter media the efficacy of the filter can degrade over time, potentially leading to fuel flow becoming impeded, degradation of filter performance, or other problems. For these reasons it is generally conventional practice to change out fuel filters on a regular service interval, or when diagnostic equipment or operator observation indicates a filter change is needed.

Filter disassembly, removal, and reinstallation is desirably a simple and easy task. For various reasons, however, filter swapping in the field is often more time consuming, labor intensive, and messy than theoretically required. Filters and related equipment often employ some type of mechanism for securely locking or positioning components in place. One common example of a filter installation and securing and/or locking mechanism includes a threaded interface. Threaded interfaces between filter components are common and have a long history of use. Certain drawbacks are nevertheless inherent to threaded designs. The force needed to connect two components may require a significant number of threads to be engaged. Numerous revolutions of an inserted part, including a filter or related components, may be required for installation and removal. Threaded components may also be susceptible to misalignment, i.e. cross-threading, which can result in one or more of the parts being stuck and/or permanently damaged. Threaded components may also be formed from relatively soft material such as plastic or aluminum and can be inadvertently tightened beyond the yield limit of the materials. These and other problems can be magnified when the threaded components are large, as is commonly the case in the off-highway machinery environment. One example replaceable filter configuration in a liquid filter context is known from U.S. Pat. No. 6,814,243B2 to Amstutz et al.

### SUMMARY

In one aspect, a fluid system includes a filter canister, a filter medium within the filter canister and a first housing component. The first housing component defines a filter axis and forms a filter medium cavity. The first housing component also includes a first plurality of thread sets and a first plurality of slots. The fluid system also includes a second housing component forming a collection cavity and including a second plurality of thread sets and a second plurality of slots. The fluid system also includes a stop including a first stop component formed upon the first housing component and a second stop component formed upon the second housing component. The first stop component contacts the second stop component at an installation orientation of the first housing component wherein the first plurality of thread sets are aligned with the second plurality of thread sets. The first housing component and the second housing component are rotatable from the installation orientation to a service orientation where the first plurality of thread sets and the second plurality of thread sets are engaged to form a connecting interface, and a drain passage extends through the connecting interface and fluidly connects the filter medium cavity to the collection cavity.

In another aspect, a connecting system for a fluid system includes a first component defining an axis and having a first peripheral surface with a first plurality of thread sets and a first plurality of slots. The connecting system also includes a second component having a second peripheral surface with a second plurality of thread sets and a second plurality of slots configured to align and engage with the first plurality of thread sets and the first plurality of slots, forming a connecting interface defining a drain passage. The filter connecting system further includes a stop including a first stop component and a second stop component formed in part upon the first component and in part upon the second component. The first stop component is structured to contact the second stop component at an angular installation orientation of the first component relative to the second component about the axis where the first plurality of thread sets and the second plurality of thread sets are axially aligned for engagement.

In yet another aspect, a filter cartridge includes a filter housing component defining a filter axis extending between a first axial end and a second axial end, and including a peripheral surface having a plurality of thread sets and a plurality of slots. The first axial end includes an axial end surface spaced axially outward of the plurality of threads sets and the plurality of slots, and a ramp element for aligning thread sets and slots of a second filter component with the plurality of thread sets and the plurality of slots of the filter housing component. The ramp element extends circumferentially around the filter axis, and slopes from a heightened ramp end to a shortened ramp end.

### BRIEF DESCRIPTION OF DRAWINGS

FIG. 1 is a perspective view of a fluid system, according to one embodiment;

FIG. 2 is a sectioned side view of a filter assembly for a fluid system, according to one embodiment;

FIG. 3 is a perspective view of a filter cartridge, according to one embodiment;

FIG. 4 is a perspective view of a portion of a filter connecting system, according to one embodiment;

FIG. 5 is another perspective view of a portion of a filter connecting system, according to one embodiment;

FIG. 6 is an axial view of a filter component, according to one embodiment;

FIG. 7 is a side view of a filter connecting system in an installation orientation; according to one embodiment; and

FIG. 8 is another side view of a filter connecting system, in two section planes, in a detented service orientation, according to one embodiment.

### DETAILED DESCRIPTION

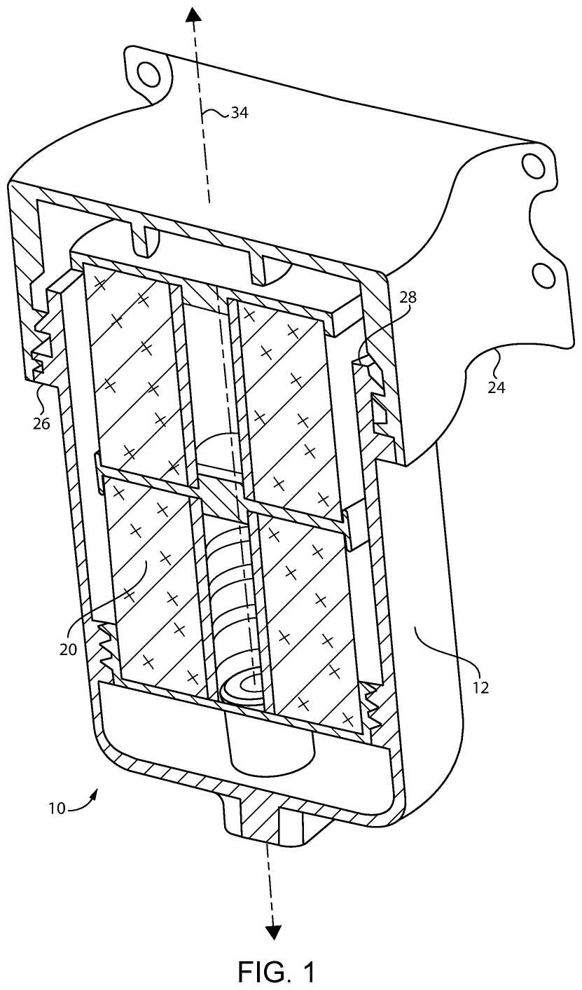

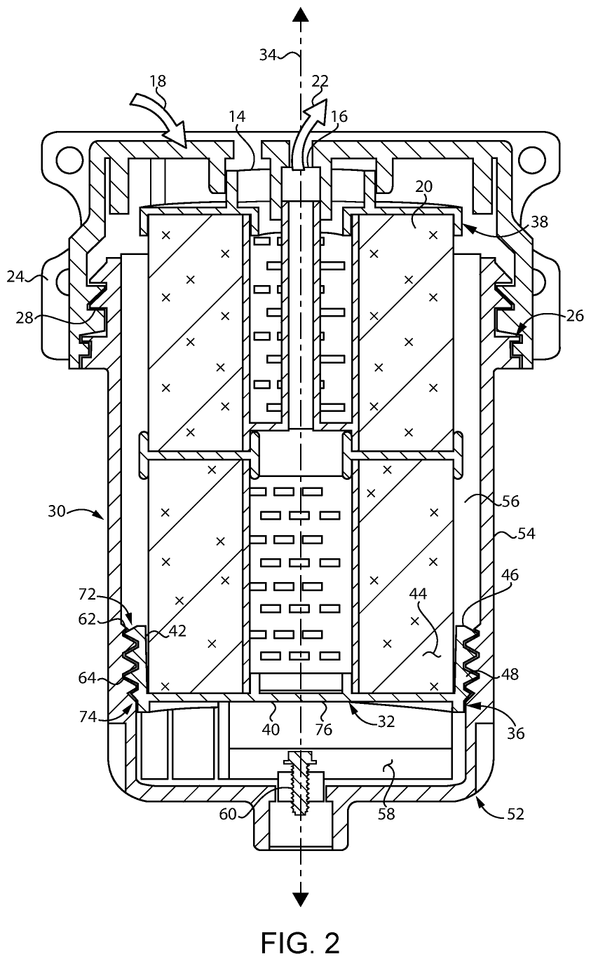

Referring to FIGS. 1 and 2, there is shown a fluid system 10, according to one embodiment. Fluid system 10 includes a filter housing or filter canister 12 having an inlet port 14 and an outlet port 16. An incoming flow 18 of a fluid to be filtered enters inlet port 14, the dirty fluid is filtered by way of a filter medium 20 within filter canister 12, and an outgoing flow 22 of filtered fluid exits by way of outlet port 16. Fluid system 10 may include a fluid system for an internal combustion engine, such as a fuel system in a compression-ignition diesel engine. Other applications are contemplated, however, such as in an engine oil system or potentially even a fluid system outside of the engine context altogether. Discussion and description herein of “fluid” or “fuel” are for descriptive purposes only, and no limitation is intended.

In one implementation, filter medium 20 may leverage gravitational forces for separation of liquids such as fuel and water as further discussed herein. Fluid system 10 may also include a filter mount or bracket 24 designed to attach to filter canister 12 and for mounting upon an engine housing or other engine hardware. To this end, filter canister 12 may include a corresponding mounting attachment 26, such as mounting threads 28, to selectively secure filter canister 12 to filter mount 24. Mounting attachment 26 may be positioned on filter canister 12 or may be structured to accommodate a subsequent addition, such as clamps, fasteners, or still others. While the present description discusses the use of mounting threads 28 configured to couple filter canister 12 to filter mount 24, it should be appreciated that mounting attachment 26 could have a variety of forms or other methods and strategies for coupling filter canister 12 to filter mount 24.

Fluid system 10 may be used to remove impurities from a liquid fuel, such as a diesel distillate fuel, gasoline, naptha, or various blends, and preventing water and other contaminants from reaching the engine. Water can be present in diesel fuel for various reasons, such as due to condensation forming on metal parts within various systems, as a contaminant in a fuel supply, etc. Moreover, over time particulates such as metal bits, carbonized material, or other debris can build up in filter medium 20. For such reasons, it is generally desirable to service fluid system 10 at defined service intervals, or where it is otherwise determined that service is needed, to remove accumulated water and/or swap in a fresh filter medium. Where filter medium 20 needs changed, a service technician can detach mounting attachment 26, and replace the exhausted or otherwise dirty filter medium 20 in filter canister 12, and reinstall filter canister 12 by reattaching mounting attachment 26 to filter mount 24. At the same time, or potentially at different intervals, water can be drained out from filter canister 12 as further discussed herein. It should be understood that the present disclosure is not limited with regard to any particular service interval or service timing, and alternative approaches for removing, servicing, and re-installing filter canister 12 are within the scope of the present disclosure.

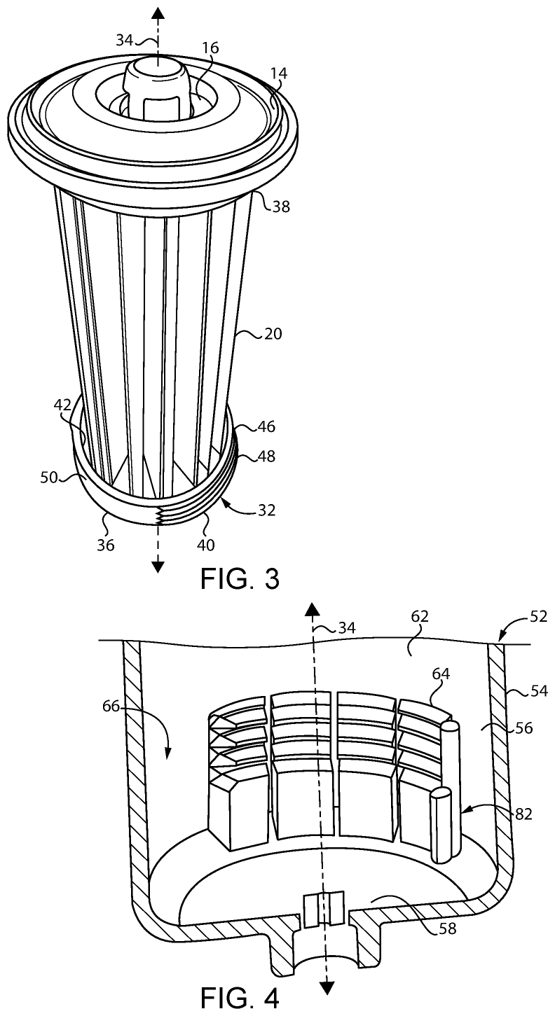

Now also referring to FIG. 3, there are shown additional details of fluid system 10. Fluid system 10 also includes a filter assembly 30 having a first housing component or “first component” 32 defining a filter axis extending between a first axial end 36 and a second axial end 38. First component 32 may include an axial end surface 40 positioned at first axial end 36. First component 32 also includes an axially extending filter receptacle 42, forming a filter medium cavity 44 receiving filter medium 20. During the filtration process, unfiltered fluid passes through filter medium 20, separating impurities such as particulates including metal bits, carbonized deposits, dirt, etc., and resulting in a filtered fluid. As shown in FIG. 3, first component 32 includes filter medium 20 attached to filter receptacle 42. A variety of filter media are known and commercially available, such as paper, polyester, activated carbon, etc. First component 32 also includes a first peripheral surface 46 spanning around and positioned radially outward of filter axis 34. Additionally, first peripheral surface 46 may include a first plurality of thread sets 48 and a first plurality of slots 50 arranged in an alternating pattern, positioned toward first axial end 36.

Now also referring to FIG. 4, fluid system 10 further includes a second housing component or “second component” 52, configured to threadingly secure first component 32 into place. Each of first component 32 and second component 52 may be coaxially arranged about filter axis 34, and each of these parts can be independently understood to define filter axis 34. It can be noted that each of first component 32 and second component 52 may be formed as a one-piece body, such as a molded plastic body or a machined or cast aluminum body, or a part formed by additive manufacturing, to name a few examples.

Second component 52 includes a second outer surface 54, and a second inner surface 56 forming a collection cavity 58. As suggested above, collection cavity 58 is structured to collect water as it drains under the force of gravity during the filtration process and circulation of the fuel through fluid system 10. To this end, collection cavity 58 may also include a removable drainage plug 60 for the evacuation of collection cavity 58 following water accumulation. In one embodiment, mounting threads 28 may be integrated onto second component 52 and positioned towards second axial end 38. Second component 52 also includes a second peripheral surface 62 positioned radially outward and spanning around filter axis 34. Second peripheral surface 62 may further include a second plurality of thread sets 64 and a second plurality of slots 66. First peripheral surface 46 may be an outer peripheral surface, and second peripheral surface 62 may be an inner peripheral surface. Embodiments are contemplated where this relationship is reversed, and thus first peripheral surface 46 might be an inner peripheral surface and second peripheral surface 62 might be an outer peripheral surface. Second plurality of thread sets 64 and second plurality of slots 66 may also be in an alternating pattern, in a manner similar to first plurality of thread sets 48 and first plurality of slots 50.

It should be understood that alternative arrangements and/or numbers of thread sets and slots are contemplated within the scope of the present disclosure, given that second plurality of thread sets 64 and second plurality of slots 66 are patterned after first plurality of thread sets 48 and first plurality of slots 50. In an example embodiment, each plurality of threads sets and plurality of slots may include a total of two thread sets and a total of two slots. Further, as shown in FIG. 5, in a refinement each plurality of threads sets and plurality of slots may be arranged such that a first diametric line 68 intersecting the two thread sets is arranged perpendicular to a second diametric line 70 intersecting the two slots.

FIG. 5 illustrates a filter connecting system 72 between first component 32 and second component 52, including certain elements of fluid system 10 already described. First component 32 and second component 52 may be rotatable from an installation orientation or arrangement to a detented service orientation or arrangement, where filter assembly 30 may further include detents as discussed subsequently to secure placement and positioning. Embodiments not including a detent feature and configured for positioning in a service arrangement that is not a detented service arrangement are nevertheless within the scope of the present disclosure.

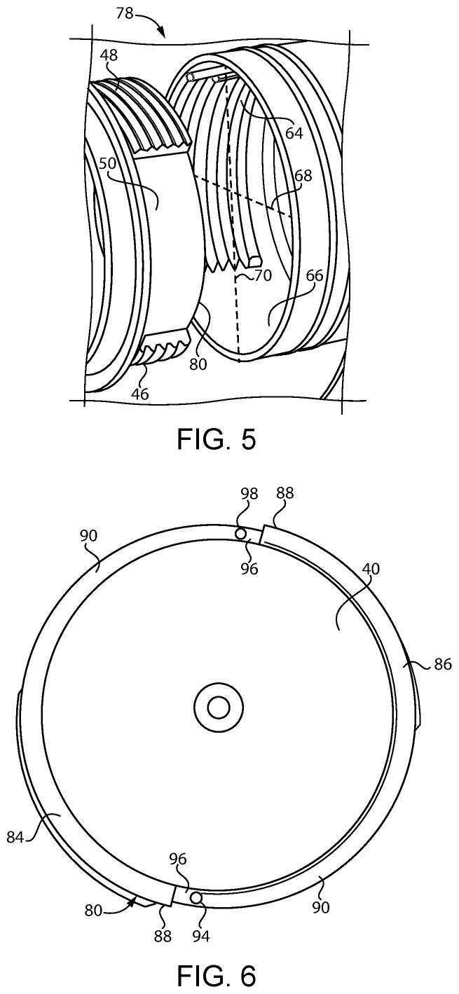

With reference additionally to FIGS. 6-8, when arranged in the detented service orientation, first plurality of thread sets 48 and second plurality of thread sets 64 are engaged, and the first plurality of slots 50 and second plurality of slots 66 are aligned to form a connecting interface 74, defining a drain passage 76 therein. Drain passage 76 is structured to extend through the connecting interface 74 when filter assembly 30 is in the detented service orientation, fluidly connecting filter medium cavity 44 to collection cavity 58 facilitating the drainage of water. It should be understood, when in the detented service orientation, drain passage 76 extends through the aligned first plurality of slots 50 and second plurality of slots 66, although some drainage through engaged threads may also occur depending upon the thread design and application. As namely implied, variations in the numbers and/or geometry of first plurality of slots 50 and second plurality of slots 66 may bring about drain passages 76 varying in number and/or configuration. For example, drain passage 76 may be one of a plurality of drain passages 76, each defined through aligned pairs of first plurality of slots 50 and second plurality of slots 66. A total of two slots in each respective component 32 and 52 could provide a total of two drain passages, a total of three slots could provide a total of three drain passages, and so on.

Filter assembly 30 may further include a stop 78 assisting in preventing thread misalignment and cross-threading. Stop 78 may be formed in part upon first component 32 and in part upon second component 52, and includes a first stop component 80 and a second stop component 82. As first component 32 and second component 52 are engaged, stop 78 may function to axially align the thread sets in the respective first component 32 and second component 52. In an embodiment, first stop component 80 may include a ramp element 84 formed upon axial end surface 40 and including a ramp surface 86. A plurality of thread sets and a plurality of slots are positioned axially between ramp element 84 and filter medium 20. Second stop component 82 may include a ramp follower 100.

Focusing on FIG. 6, ramp element 84 may circumferentially extend less than 360° around filter axis 34, and such that ramp surface 86 slopes in an axial direction from a heightened ramp end 88 to a shortened ramp end 90. Ramp element 84 may extend approximately 90°, provided it ensures guided engagement of ramp follower 100, although the present disclosure is not thereby limited. It should be understood that the term “heightened” denotes a portion of ramp element 84 extending relatively further from axial end surface 40 in an axial direction, and the term “shortened” denotes a portion of ramp element 84 extending relatively less in that axial direction than heightened ramp end 88. Ramp element 84 may also include a drop face 92 positioned at heightened ramp end 88, extending from ramp surface 86 to axial end surface 40.

Ramp element 84 may be structured for aligning second plurality of thread sets 64 and second plurality of slots 66 of second component 52 with first plurality of thread sets 48 and first plurality of slots 50 of first component 32. When first component 32 and second component 52 are advanced toward one another in an axial direction, stop 78 functions to provide a positive contact stop at an orientation where thread sets 48 and 64 are axially aligned for threaded engagement.

As also suggested above, first component 32 may further include a detent feature 94 formed on axial end surface 40. Detent feature 94 may be positioned adjacent to heightened ramp end 88, defining a detent pocket 96 extending circumferentially between detent feature 94 and heightened ramp end 88. Various configurations of detent feature 94 are within the scope of the present disclosure. In one example, detent feature 94 may include a detent bump 98. In other examples, detent feature 94 might include a clip, a slot, a hook, or any of a variety of other shapes, forms, and alternative positioning, provided it releasably secures second stop component 82 in the detented service orientation and provides some resistance against twisting apart first component 32 and second component 52. By providing a detented arrangement, during disassembly of first component 32 and second component 52, filter assembly 30 may maintain connection between first component 32 and second component 52 as threads 28 are disengaged during removal from filter mount 24. It should also be understood that there may exist a plurality of ramp elements 84 and a plurality of detent features 94 formed on axial end surface 40, each detent feature 94 positioned adjacent to one heightened ramp end 88, and potentially each detent feature 94 positioned adjacent one shortened ramp end 90. Thus, a plurality of ramp elements 84 and a plurality of detent features 94 may be arranged in an alternating pattern around filter axis 34, and may be located adjacent to first peripheral surface 46 in a radial direction.

Second stop component 82 may further include a ramp follower 100 formed on second peripheral surface 62, adjacent to second plurality of thread sets 64 and extending toward second axial end 38. Ramp follower 100 may be structured for traversal of ramp element 84 when rotating first component 32 relative to second component 52. It can be noted that as first component 32 rotates, ramp follower 100 contacts and follows ramp element 84. Although the present description discusses ramp follower 100 extending in an axial direction, alternative placements and forms of ramp follower 100 are contemplated. For example, ramp follower 100 may be located adjacent to second peripheral surface 62 in a radial direction, given ramp element 84 and detent feature 94 are located adjacent first peripheral surface 46 in a radial direction. There may exist a plurality of ramp followers 100 corresponding to the number of ramp elements 84.

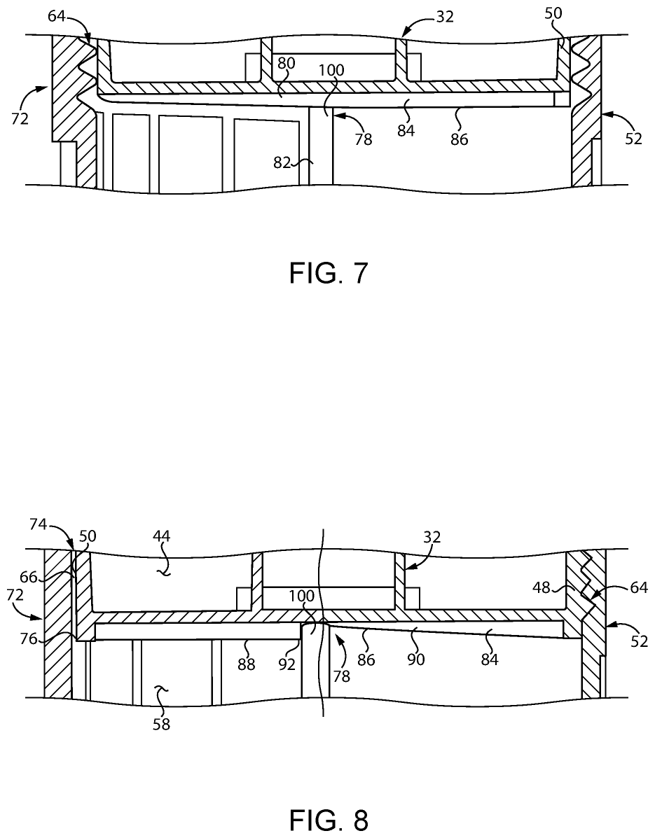

Now focusing on FIGS. 7 and 8, there is shown filter connecting system 72 in the installation orientation and in the detented service orientation, respectively. As the present description discusses, first component 32 may be positioned about filter axis 34 in the installation orientation at which first plurality of thread sets 48 can be inserted into second plurality of slots 66, and then rotated via engagement of first plurality of thread sets 48 and second plurality of thread sets 64, to the detented service orientation. As first component 32 rotates relative to second component 52, ramp follower 100 may be continuously in contact with ramp element 84 at a range of angular installation orientations of first component 32 relative to second component 52. In the course of rotation, ramp follower 100 may circumferentially travel between shortened ramp end 90 and heightened ramp end 88. In a practical embodiment, first component 32 may rotate clockwise approximately a one-quarter turn relative to second component 52, although the present description is not limited as such.

Just prior to reaching the detented service orientation ramp follower 100 may pass over detent bump 96 to enter detent pocket 96 and be trapped between detent bump 96 and drop face 92. In this configuration, slots 50 may aligned with slots 66, and drain passage(s) 76 enable drainage of water received into collection cavity 58.

### INDUSTRIAL APPLICABILITY

Referring to the drawings generally, it will be recalled it is generally desirable to replace used filters for fresh filters periodically, either at predetermined intervals or on an as-needed-basis. A user can remove second component 52, manually, or with the assistance of a tool from filter mount 24. In one embodiment, the user uninstalls mounting threads 28 on second component 52 by rotating in a first direction and slides second component 52 off of filter mount 24. If filter medium 20 is to be replaced, a replacement filter medium or first component 32 with an attached filter medium can then be installed by initially removing the exhausted filter. To install the replacement, a fresh first component 32 with attached filter medium (a “filter cartridge”) can be positioned in the installation orientation and rotated to engage second component 52. As discussed herein, first stop component 80 may contact second stop component 82 at the installation orientation of first component 32 and second component 52 to align thread sets 48 with thread sets 64. As first component 32 rotates relative to second component 52, first stop component 80 is continuously in contact with second stop component 82, at a range of angular orientations, from the installation orientation to the detented service orientation. With first component 32 and second component 52 coupled together, the assembly thereof can be reinstalled in filter mount 24 and fluid system 10 returned to service.

As will be apparent, the present disclosure contemplates a threaded connection between parts in a fluid system where fluid can be drained through the threaded interface itself. The strategy differs from certain earlier designs where O-rings or the like participated in locating threads for engagement, but then provided a fluid seal that would prevent any drainage through a threaded interface. While the field of engine fuel systems is contemplated as a practical implementation strategy, it should be appreciated that a variety of other environments may benefit by way of application of the teachings herein, and various other fluid connections for filters, between two fluid conduits, between a fluid conduit and another structure such as a tank, or still others are contemplated herein. Filter system 10 or parts thereof can be sold as original equipment or as one or more aftermarket products, including provided as a replacement filter cartridge including first component 32 and attached filter medium 20.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A fluid system comprising:
a filter canister;
a filter medium within the filter canister; and
a first housing component defining a filter axis and forming a filter medium cavity, the first housing component including a first plurality of thread sets and a first plurality of slots;
a second housing component forming a collection cavity and including a second plurality of thread sets and a second plurality of slots;
a stop including a first stop component formed upon the first housing component and a second stop component formed upon the second housing component;
the first stop component contacts the second stop component at an installation orientation of the first housing component and the second housing component aligning the first plurality of thread sets with the second plurality of thread sets; and
the first housing component and the second housing component are rotatable from the installation orientation to a service orientation where the first plurality of thread sets and the second plurality of thread sets are engaged to form a connecting interface, and a drain passage extends through the connecting interface and fluidly connects the filter medium cavity to the collection cavity.

2. The fluid system of claim 1 wherein, in the installation orientation the first plurality of thread sets are within the second plurality of slots and the second plurality of thread sets are within the first plurality of slots.

3. The fluid system of claim 2 wherein the first plurality of thread sets and the first plurality of slots are in an alternating pattern and the second plurality of thread sets and the second plurality of slots are in an alternating pattern.

4. The fluid system of claim 3 wherein, in the service orientation the first plurality of slots are aligned with the second plurality of slots, and wherein the drain passage is one of a plurality of drain passages each extending through aligned pairs of the first plurality of slots and the second plurality of slots.

5. The fluid system of claim 1 wherein the first stop component is continuously in contact with the second stop component, at a range of angular orientations of the first housing component relative to the second housing component about the filter axis, from the installation orientation to the service orientation.

6. A connecting system for a fluid system comprising:
a first component defining an axis and including a first peripheral surface having a first plurality of thread sets and a first plurality of slots;
a second component including a second peripheral surface having a second plurality of thread sets and a second plurality of slots configured to align and engage with the first plurality of thread sets and the first plurality of slots, forming a connecting interface defining a drain passage;
a stop including a first stop component and a second stop component formed in part upon the first component and in part upon the second component; and
the first stop component is structured to contact the second stop component at an angular installation orientation of the first component relative to the second component about the axis where the first plurality of thread sets and the second plurality of thread sets are axially aligned for engagement.

7. The connecting system of claim 6 wherein the first peripheral surface is an outer peripheral surface, and the second peripheral surface is an inner peripheral surface.

8. The connecting system of claim 7 wherein the first component is rotatable relative to the second component to a detented service orientation.

9. The connecting system of claim 8 further including a detent feature adjacent to the first stop component and in securing contact with the second stop component, and the drain passage is one of a plurality of drain passages defined through the connecting system between the first component and the second component.

10. The connecting system of claim 6 wherein the first stop component includes a ramp element sloping from a heightened ramp end to a shortened ramp end and extending less than 360° around the axis from the heightened ramp end to the shortened ramp end.

11. A filter cartridge comprising:
a filter housing component defining a filter axis extending between a first axial end and a second axial end, and including a peripheral surface having a plurality of thread sets and a plurality of slots;
the first axial end including an axial end surface spaced axially outward of the plurality of threads sets and the plurality of slots, and a ramp element for aligning thread sets and slots of a second filter component with the plurality of thread sets and the plurality of slots of the filter housing component;
the ramp element extending circumferentially around the filter axis, and sloping from a heightened ramp end to a shortened ramp end.

12. The filter cartridge of claim 11 wherein the first axial end further includes a detent feature adjacent to the heightened ramp end.

13. The filter cartridge of claim 12 wherein the detent feature includes a detent bump.

14. The filter cartridge of claim 13 further including a detent pocket extending circumferentially between the detent bump and the heightened ramp end.

15. The filter cartridge of claim 12 wherein the ramp element is one of a plurality of ramp elements and the detent feature is one of a plurality of detent features, formed on the axial end surface.

16. The filter cartridge of claim 15 wherein the plurality of ramp elements and the plurality of detent features are arranged in an alternating pattern around the filter axis and located adjacent to the peripheral surface in a radial direction.

17. The filter cartridge of claim 11 wherein the peripheral surface is an outer peripheral surface circumferentially extending around the filter axis.

18. The filter cartridge of claim 17 wherein the plurality of thread sets and the plurality of slots includes a total of two thread sets and a total of two slots.

19. The filter cartridge of claim 18 wherein a diametric line intersecting the two thread sets is arranged perpendicular to a diametric line intersecting the two slots.

20. The filter cartridge of claim 11 further comprising a filter medium attached to the filter housing component, and wherein the plurality of thread sets and the plurality of slots are positioned axially between the ramp element and the filter medium.
